(19) United States
(12) Patent Application Publication
(10) Pub. No.: US 2017/0211709 A1
(43) Pub. Date: Jul. 27, 2017

(54) FOUR-WAY SWITCHING VALVE CORE

(71) Applicant: Xiamen Runner Industrial Corporation, Xiamen (CN)

(72) Inventors: BU-KONG XIE, Xiamen (CN); SHANG-GUI CHEN, Xiamen (CN); QING-ZHAO HE, Xiamen (CN)

(21) Appl. No.: 15/410,772

(22) Filed: Jan. 20, 2017

(30) Foreign Application Priority Data
Jan. 27, 2016 (CN) 201620078917.8

(51) Int. Cl. F16K 11/074; F16K 25/00

(52) U.S. Cl. CPC F16K 11/074; F16K 25/005

(57) ABSTRACT

A four-way switching valve core, comprising: a valve core shell; a rotation axis, with its upper end penetrating through the valve core shell; a fixing seat, connected to a lower end of the rotation axis; an upper ceramic plate, connected to a lower end of the fixing seat; a bottom cover, on which is provided with four water input-output ports, and is connected to a lower end of the valve core shell; a lower ceramic plate, on which is provided with four water passage holes, connected to and in communication with the four water input-output ports, and is connected to the bottom cover; and a water passage slot set, disposed on the upper ceramic plate, used to open and close the water passage holes. The four-way switching valve core further includes: a slot hole, a bead, a spring, and four position blocking slots.

### BACKGROUND OF THE INVENTION

Field of the Invention

The present invention relates to a switching valve core, and in particular to a four-way switching valve core.

The Prior Arts

In operations relating to water channels of a water supply system, a switching valve is essential. However, presently, the structure of a water channel switching valve used for a faucet is rather complicated; while for the existing switching valve, the number of switching gears that can be switched is limited. Further, since the switching elements in the valve core are subject to the pressure of water, thus in switching between the valve gears, great force has to be applied. Therefore, in manual operation, it does not provide good hand feel and easy handling.

Therefore, presently, the design and performance of the switching valve core is not quite satisfactory, and it leaves much room for improvement.

### SUMMARY OF THE INVENTION

In view of the problems and drawbacks of the prior art, the present invention provides a four-way switching valve core, to overcome the shortcomings of the prior art.

The present invention provides a four-way switching valve core, comprising: a valve core shell; a rotation axis, with its upper end penetrating through the valve core shell; a fixing seat, connected to a lower end of the rotation axis; an upper ceramic plate, connected to a lower end of the fixing seat; a bottom cover, on which is provided with four water input-output ports, and is connected to a lower end of the valve core shell; a lower ceramic plate, on which is provided with four water passage holes, is connected to and in communication with the four water input-output ports, and is connected to the bottom cover; and a water passage slot set, disposed on the upper ceramic plate, and is used to open and close the water passage holes.

According to an aspect of the present invention, the present invention further includes a plurality of upper ceramic plate fastening slots, disposed evenly around an outer perimeter of the upper ceramic plate; and a lower protrusion portion, disposed at a lower end of the fixing seat, to fast and connect to the upper ceramic plate fastening slot.

According to another aspect of the present invention, the present invention further includes: a plurality of lower ceramic plate fastening slots, disposed evenly around an outer perimeter of the lower ceramic plate; and an upper protrusion portion, disposed at an upper end of the bottom cover, to fasten and connect to the lower ceramic plate fastening slot.

According to yet another aspect of the present invention, the present invention further includes; a protrusion pin, disposed at a lower end of the rotation axis; and a fastening slot, disposed on f the fixing seat; to act in cooperation with the protrusion pin, to bring the fixing seat into rotation.

According to a further aspect of the present invention, the present invention further includes: two tight seal rings, disposed respectively at two sides of the water input-output ports.

According to another aspect of the present invention, the present invention further includes: a rotation axis tight seal ring, disposed between the rotation axis and the valve core shell.

According to yet another aspect of the present invention, the present invention further includes: a valve core tight seal ring, disposed around an outer perimeter of the valve core shell, to act in cooperation with a valve core seat.

According to a further aspect of the present invention, the present invention further includes: a slot hole, disposed on an upper surface of the fixing seat; a bead, disposed in the slot hole; a spring, disposed in the slot hole and below the bead; and four position blocking slots, disposed in intervals in a top portion of an inner chamber in the valve core shell, to act in cooperation with the bead.

According to another aspect of the present invention, the water passage slot set includes: a long water passage slot and a short water passage slot.

Compared with the Prior Art, the present invention has the advantages that, it is simple in construction, novel in design, and is capable of switching between four switching gears, namely, to switch between water flows of different water output ports. The bottom of the valve core is tight seal in double, while no water pressure is exerted between the upper ceramic plate and the lower ceramic plate, such that the force required for switching between gears can be reduced, in achieving good hand feel and easy handling.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a cross section view of a four-way switching valve core according to the present invention;

FIG. 2 is an exploded view of a four-way switching valve core according to the present invention;

FIG. 3 is a schematic diagram of switching gear position 1 of a four-way switching valve core according to the present invention;

FIG. 4 is a schematic diagram of switching gear position 2 of a four-way switching valve core according to the present invention;

FIG. 5 is a schematic diagram of switching gear 3 of a four-way switching valve core according to the present invention; and

FIG. 6 is a schematic diagram of switching gear 4 of a four-way switching valve core according to the present invention.

### DETAILED DESCRIPTIONS OF THE PREFERRED EMBODIMENT

The purpose, construction, features, functions and advantages of the present invention can be appreciated and understood more thoroughly through the following detailed descriptions with reference to the attached drawings.

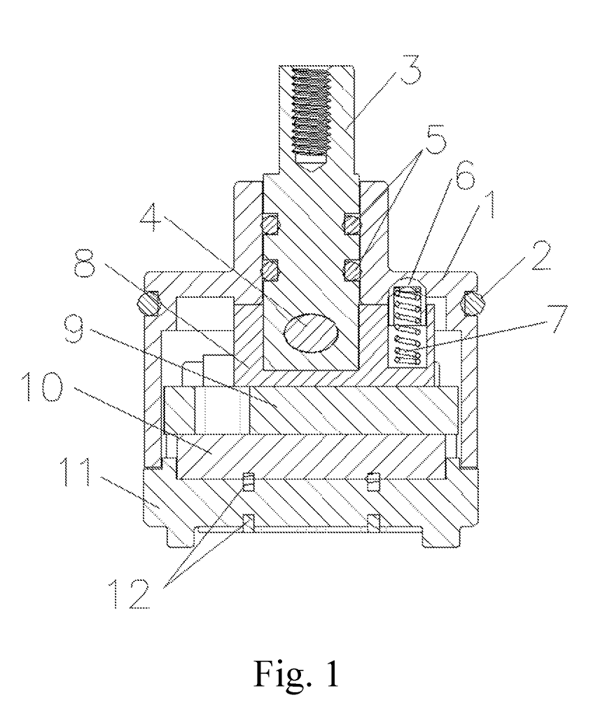

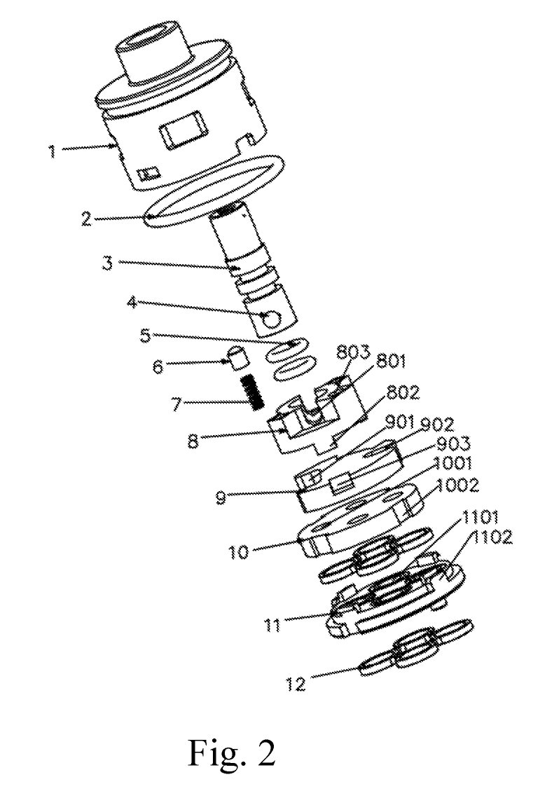

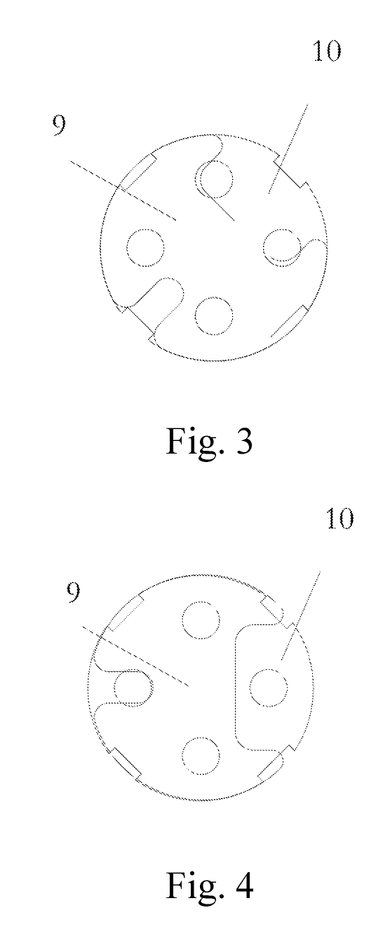

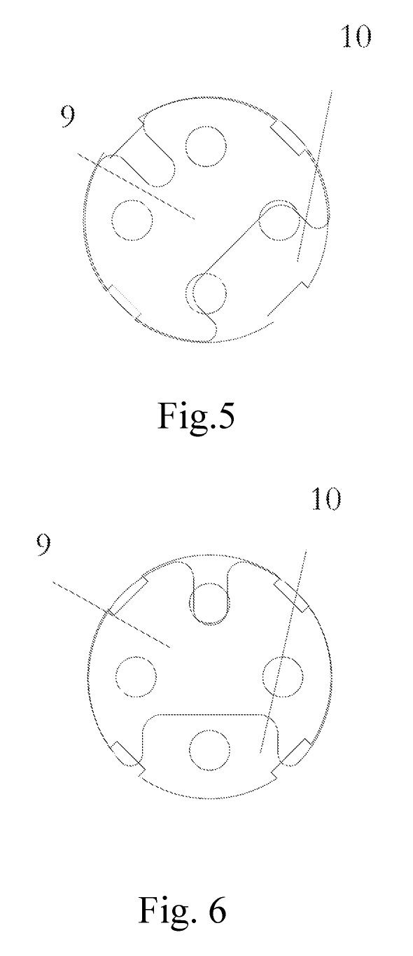

Refer to FIGS. 1 to 6 respectively for a cross section view of a four-way switching valve core according to the present invention; an exploded view of a four-way switching valve core according to the present invention; a schematic diagram of switching gear position 1 of a four-way switching valve core according to the present invention; a schematic diagram of switching gear position 2 of a four-way switching valve core according to the present invention; a schematic diagram of switching gear 3 of a four-way switching valve core according to the present invention; and a schematic diagram of switching gear 4 of a four-way switching valve core according to the present invention.

As shown in FIGS. 1 to 6, the present invention provides a four-way switching valve core, comprising: a valve core shell 1; a rotation axis 3, with its upper end penetrating through the valve core shell 1; a fixing seat 8, connected to a lower end of the rotation axis 3; an upper ceramic plate 9, connected to a lower end of the fixing seat 8; a bottom cover 11, on which is provided with four water input-output ports 1101, and is connected to a lower end of the valve core shell 1; a lower ceramic plate 10, on which is provided with four water passage holes 1001, is connected to and in communication with the four water input-output ports 1101, and is connected to the bottom cover 11; and a water passage slot set, disposed on the upper ceramic plate 9, and is used to open and close the water passage holes 1001. Through rotation of the rotation axis 3, the upper ceramic plate 9 is brought into rotation, so that its water passage slot set is actuated to open any two of the four water passage holes 1001.

According to an embodiment of the present invention, the present invention further includes a plurality of upper ceramic plate fastening slots 903, disposed evenly around an outer perimeter of the upper ceramic plate 9; and a lower protrusion portion 802, disposed at a lower end of the fixing seat 8, to fast and connect to the upper ceramic plate fastening slot 903.

According to an embodiment of the present invention, the present invention further includes: a plurality of lower ceramic plate fastening slots 1002, disposed evenly around an outer perimeter of the lower ceramic plate 10; and an upper protrusion portion 1102, disposed at an upper end of the bottom cover 11, to fasten and connect to the lower ceramic plate fastening slot 1002.

According to an embodiment of the present invention, the present invention further includes; a protrusion pin 4, disposed at a lower end of the rotation axis 3; and a fastening slot 801, disposed on f the fixing seat 8; to act in cooperation with the protrusion pin 4, to bring the fixing seat 8 into rotation.

According to an embodiment of the present invention, the present invention further includes: two tight seal rings 12, disposed respectively at two sides of the water input-output ports 1101.

According to an embodiment of the present invention, the present invention further includes: a rotation axis tight seal ring 5, disposed between the rotation axis 3 and the valve core shell 1.

According to an embodiment of the present invention, the present invention further includes: a valve core tight seal ring 2, disposed around an outer perimeter of the valve core shell 1, to act in cooperation with a valve core seat.

According to an embodiment of the present invention, the present invention further includes: a slot hole 803, disposed on an upper surface of the fixing seat 8; a bead 6, disposed in the slot hole 803; a spring 7, disposed in the slot hole 803 and below the bead 6; and four position blocking slots (not shown), disposed in intervals in a top portion of an inner chamber in the valve core shell 1, to act in cooperation with the bead 6. There are altogether 4 position blocking slots, having an angle between two adjacent position blocking slots of 45°, so that the upper ceramic plate 9 is able to rotate and switch between the four switching gears for every 45°.

According to an embodiment of the present invention, the water passage slot set includes: a long water passage slot 901 and a short water passage slot 902. The short water passage slot 902 is able to open or close a water passage hole 1001; while long water passage slot 901 is able to open or close one or two water passage hole 1001, based on the rotated switching gear.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A four-way switching valve core, comprising:
a valve core shell;
a rotation axis, with its upper end penetrating through the valve core shell;
a fixing seat, connected to a lower end of the rotation axis;
an upper ceramic plate, connected to a lower end of the fixing seat;
a bottom cover, on which is provided with four water input-output ports, and is connected to a lower end of the valve core shell;
a lower ceramic plate, on which is provided with four water passage holes, connected to and in communication with the four water input-output ports, and is connected to the bottom cover; and
a water passage slot set, disposed on the upper ceramic plate, used to open and close the water passage holes.

2. The four-way switching valve core as claimed in claim 1, further comprising:
a plurality of upper ceramic plate fastening slots, disposed evenly around an outer perimeter of the upper ceramic plate; and
a lower protrusion portion, disposed at a lower end of the fixing seat, to fast and connect to the upper ceramic plate fastening slot.

3. The four-way switching valve core as claimed in claim 1, further comprising:
a plurality of lower ceramic plate fastening slots, disposed evenly around an outer perimeter of the lower ceramic plate; and
an upper protrusion portion, disposed at an upper end of the bottom cover, to fasten and connect to the lower ceramic plate fastening slot.

4. The four-way switching valve core as claimed in claim 1, further comprising:
a protrusion pin, disposed at a lower end of the rotation axis; and
a fastening slot, disposed on the fixing seat; to act in cooperation with the protrusion pin, to bring the fixing seat into rotation.

5. The four-way switching valve core as claimed in claim 1, further comprising:
two tight seal rings, disposed respectively at two sides of the water input-output ports.

6. The four-way switching valve core as claimed in claim 1, further comprising:
a rotation axis tight seal ring, disposed between the rotation axis and the valve core shell.

7. The four-way switching valve core as claimed in claim 1, further comprising:
a valve core tight seal ring, disposed around an outer perimeter of the valve core shell.

8. The four-way switching valve core as claimed in claim 1, further comprising:
a slot hole, disposed on an upper surface of the fixing seat;
a bead, disposed in the slot hole;
a spring, disposed in the slot hole and below the bead; and
four position blocking slots, disposed in intervals in a top portion of an inner chamber in the valve core shell, to act in cooperation with the bead.

9. The four-way switching valve core as claimed in claim 1, wherein
the water passage slot set includes: a long water passage slot and a short water passage slot.
